(19) United States
(12) Patent Application Publication
(10) Pub. No.: US 2012/0102427 A1
(43) Pub. Date: Apr. 26, 2012

(54) SYSTEMS AND METHODS FOR AUTOMATED CLAIM CHART GENERATION

(76) Inventors: Marc Aaron Fenster, Palisades, CA (US); Patrick Anderson, Sanchse, TX (US); Daniel Bork, East Kingston, NH (US); Brad Sheafe, Monticello, IL (US)

(21) Appl. No.: 13/277,343

(22) Filed: Oct. 20, 2011

Related U.S. Application Data
(60) Provisional application No. 61/405,483, filed on Oct. 21, 2010.

(51) Int. Cl. G06F 3/048; G06F 17/30

(52) U.S. Cl. 715/780; 707/792; 707/E17.014

(57) ABSTRACT

A method and system provide automated claim chart generation. The method and system import claims and related information regarding at least one patent The method and system create an initial claim chart for the patent, receive user edits to the claim elements of the claims, and process the user edits to the claim elements. After detecting a user edit to an element a first claim that is repetitive of a second claim, the method and system automatically update the corresponding element of the second claim. The method and system create a product template that includes product identifiers, product characteristics, and evidence showing that the products have the product characteristics. The method and system perform a case analysis, receive an input mapping the product characteristics to the claim elements in the initial claim chart, and generate a claim infringement analysis chart combining the mapped claim elements and the product characteristics.

### CROSS-REFERENCE TO RELATED APPLICATIONS

This application claims the priority of U.S. Provisional Application Ser. No. 61/405,483, entitled “Systems and Method for Automated Claim Chart Generation,” which was filed Oct. 21, 2010 and is incorporated herein by reference.

### BACKGROUND

Claim charts are a useful way of evaluating a set of patent claims in a variety of contexts. For example, in patent litigation today, both defendants and plaintiffs must create claim charts that demonstrate whether a patent is infringed or not or whether a patent is valid or not. Patent owners and their attorneys create and use claim charts prior to filing of a patent infringement complaint, when analyzing whether a potential defendant's products infringe the patent owner's patent or not. Likewise, interested parties create and use claim charts when analyzing whether a patent is valid over prior art. During litigation, the plaintiff will create and provide claim charts demonstrating infringement of the plaintiff's patent(s) while the defendant will create and provide charts demonstrating the invalidity of the plaintiff's patent(s).

Unfortunately, claim chart creation is a manually intensive, time-consuming and arduous process. Many hours are spent creating claim charts, and there exists no effective system for speeding up the process of claim chart generation. Moreover, there is no effective way for supervising attorneys to monitor the progress of claim chart generation by junior attorneys and others. Further, much of the effort in generating a claim chart is duplicative, and no present system effectively takes advantage of this duplicative nature and reduces the steps necessary to generate a claim chart.

### SUMMARY

An embodiment of a method for automated claim chart generation includes importing claims and related information regarding at least one patent to be charted using at least one processor, and creating an initial claim chart for the at least one patent using the at least one processor. The at least one patent includes one or more claims, and each claim includes one or more claim elements. The method further includes receiving user edits to the one or more claim elements of the one or more claims in the initial claim chart, and processing the user edits to the one or more claim elements of the one or more claims in the initial claim chart to update the initial claim chart using the at least one processor. After detecting a user edit to an element a first claim that is repetitive of a second claim, the method automatically updates the corresponding element of the second claim. The method further includes creating a product template that includes one or more of product identifiers of one or more products, product characteristics of the one or more products, and evidence showing that the one or more products have the product characteristics, performing a case analysis using the at least one processor, receiving an input mapping the product characteristics to the one or more claim elements in the initial claim chart, and generating a claim infringement analysis chart combining the mapped claim elements and the product characteristics using the at least one processor.

An embodiment of a system for automated claim chart generation includes means for importing claims and related information regarding at least one patent to be charted, and means for creating an initial claim chart for the at least one patent. The at least one patent includes one or more claims, and each claim includes one or more claim elements. The system further includes means for receiving user edits to the one or more claim elements of the one or more claims in the initial claim chart, and means for processing the user edits to the one or more claim elements of the one or more claims in the initial claim chart to update the initial claim chart. After detecting a user edit to an element a first claim that is repetitive of a second claim, the system automatically updates the corresponding element of the second claim. The system further includes means for creating a product template that includes one or more of product identifiers of one or more products, product characteristics of the one or more products, and evidence showing that the one or more products have the product characteristics, means for performing a case analysis, means for receiving an input mapping the product characteristics to the one or more claim elements in the initial claim chart, and means for generating a claim infringement analysis chart combining the mapped claim elements and the product characteristics.

### BRIEF DESCRIPTION OF DRAWINGS

The detailed description will refer to the following drawings, wherein like numerals refer to like elements, and wherein:

FIG. 1 is a flowchart illustrating an embodiment of a method for automated claim chart generation.

FIGS. 2-10 are exemplary user interfaces provided by embodiments of the method for automated claim chart generation.

FIG. 11 is a flow chart illustrating another embodiment of a method for automated claim chart generation.

FIG. 12 is a block diagram of an embodiment of a system for automated claim chart generation.

### DETAILED DESCRIPTION

Described herein are embodiments of a system and method for automated claim chart generation. Embodiments overcome the problems described above. For example, embodiments automate much of the process of generating claim charts, reducing the time necessary to generate a claim chart and simplifying the process. Embodiments enable supervising attorneys to effectively supervise and monitor the progress of claim chart generation by junior attorneys and others. Embodiments also take advantage of the duplicative nature of claim charts and enable users to replicate portions, such as claim elements and product characteristics, which are repeated for different claims and different products.

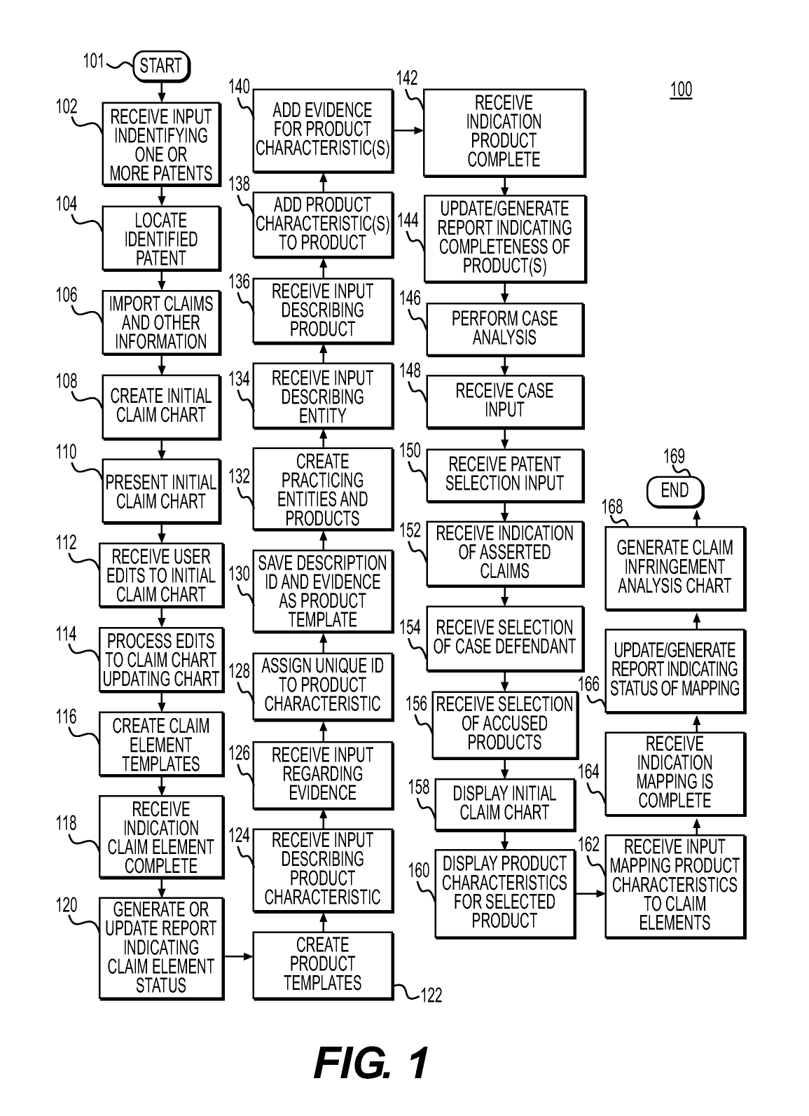

With reference now to FIG. 1, shown is exemplary embodiment of a method 100 for automated claim chart generation. In embodiments, a processor performs method 100 by executing an application stored in memory (e.g., a computer comprising a processor, a memory and an input device, runs the application). Method 100 starts (block 101) by receiving input identifying one or more patents to be charted, block 102. Typically, the received 102 input includes a patent number or other identifying indicia of a patent (e.g., title, etc.). The input may be received from a user typing in and submitting a patent number in a text box, a user selecting a patent from a list of patents, or from another application or computer. Method 100 locates the identified patent, block 104, and imports the claims and other information regarding the patent, block 106. The identified patent may be located 104 in an online patent database such as Patent Calls™, USPTO.gov, and Google Patents™. The locating 104 may identify and retrieve a source file for the identified patent. Method 100 may import 106 the claims and other information regarding the patent from the same database. The claims and information may be imported 106 from the retrieved source file. The other information imported 106 may include bibliographic information regarding the patent, including title, inventors, assignees, issue date, filing date, priority date, etc.

Method 100 creates initial claim chart from imported 106 claims, block 108. Method 100 creates 108 claim chart by dividing each claim up into its component parts and inserting these component parts into a table. The claims may be divided by first separating the preamble out, e.g., as indicated by the first colon in the claim (i.e., the preamble is assumed to start at the beginning of the claim and end at the first colon) and then separating elements in the claim, e.g., as indicated by semi-colons and subsequent colons. After creating 108 the initial claim chart, method 100 may present the initial claim chart to a user, block 110. The initial claim chart may be presented 110 by displaying on a monitor or other computing device display.

With continuing reference to FIG. 1, the user may want to edit the initial claim chart. For example, not all component parts represent distinct are separated by semi-colons or colons (e.g., some are separated by commas or without any punctuation). Furthermore, some component parts include multiple claim elements, limitations, features, or sub-elements that need to be, or that the user wants to have, separately addressed in the claim chart. Moreover, the source patent file may have errors in it or errors may have been introduced in the importing 106 of the claims. Accordingly, method 100 may receive user edits to the initial claim chart, block 112. The user may edit specific claim text, add claim text, add claim elements, sub-divide a component part into separate parts. The user may also edit, remove or add claim dependencies. The method 100 may receive 112 the edits through free-form text entry boxes, menu selections, etc. displayed with the claim chart on a user interface (e.g., see below). Method 100 processes the received 112 user edits, block 114. When a user enters edits for a claim, the user may select an update button to indicate that the element has been edited and the edits should be processed 114. Processing 114 may change the claim chart per the received user edits. If the user creates new elements or sub-elements, the processing 114 may create element templates, block 116. Element templates are allow the user to re-use the created element or sub-element in other claims. Element templates may be stored in a drop down menu, or other type of menu, so that a user may enter edits by selecting a previously created element template. Consequently, if multiple claims have the same element, the user will not have to manually re-edit that element in the other claims. For example, if a component part in claim 1 in an initial claim chart is sub-divided into four elements, the four elements may be input by the user and received 112. Claim element templates are created 116. Subsequently, when the user edits the same element in a subsequent claim, the user may simply select the claim element templates rather than re-typing the elements. In this manner, method 100 takes advantage of the duplicity in the claim.

As shown in FIG. 1, the editing 112, processing 114 and creating 116 may be repeated as the user edits the initial claim chart. When a user completes editing a claim element, the user may indicate that the element is complete. Consequently, method 100 may receive indication that element is complete, block 118. For example, a user may simply click an interface button indicating the claim element is complete. Method 100 may generate a report indicating completeness of initial claim chart, block 120. The report may be updated and generated 120 every time there is a change in the completeness of a claim element (e.g., an indication that a claim element is complete is received 118). The generated 120 report provides an indication to supervising attorneys and others of the status of the initial claim chart.

With continuing reference to FIG. 1, method 100 creates product templates, block 122. Product templates include a product identifier, product characteristics and evidence showing the product has the product characteristics. The product characteristics may be repeatedly used for multiple products. Creating 122 product templates includes receiving input describing a product characteristic, block 124. A user may enter the input through a text box, menu, or other input mechanism on a product template interface displayed on a computing device. Typically, the user types the characteristic description in a text box, although the description may include graphics. Creating 122 also includes receiving input regarding the evidence, block 126. The user input may include a description of the evidence as well as the evidence itself. For example, the user may enter the description through a text box, menu, or other input mechanism on a product template interface displayed on a computing device. Additionally, the user may input the evidence by uploading a file that is a graphical illustration, product diagram, picture, etc. showing the characteristic. The file may be, e.g., a .png, .jpeg, or .gif file, or other similar file. In embodiments, the file should enable the evidence to be incorporated and displayed in the final claim chart. Creating 122 may include assigning a unique identifier (ID) to the product characteristic, block 128. Creating 122 may save the description, evidence and ID as a product template for future use, block 130. In this manner, user may select the product template and insert into the claim chart (see below), for multiple claims, without having to re-create the product characteristic. Likewise, the user may select the product template for multiple products having the same characteristic. The creating 122 may be repeated for multiple product characteristics.

Method 100 creates practicing entities and products, block 132. Creating 132 the practicing entity includes receiving input describing the entity (e.g., a manufacturer, distributor, etc.), block 134, and receiving input describing the entity's product, block 136. A user may enter the input through a text box, menu, or other input mechanism on an interface displayed on a computing device. The entity information may be a name, address, etc. The product information may include a name, model number, manufacturer, etc. Creating 132 includes adding product characteristic to the product, block 138. The product characteristics may be added 138 by receiving user selections of product characteristic templates. Alternatively, product characteristics may be added 138 by receiving user input of characteristic unique to the product. Such unique characteristics may be added through a text box, menu, or other input mechanism on an interface displayed on a computing device. Creating 132 may also include adding evidence for the product characteristic, block 140. The evidence may be simply the evidence in the product characteristic template. Alternatively, evidence may be added 140 that is unique to the product or model. The creating 132 may be repeated for multiple products.

The user may indicate that a product and/or product characteristic is complete. Consequently, method 100 may receive indication that product and/or product characteristic is complete, block 142. For example, a user may simply click an interface button indicating a product and/or product characteristic is complete. Method 100 may generate a report indicating completeness of infringing products, block 144. The report may be updated and generated 144 every time there is a change in the completeness of a product and/or product characteristic (e.g., an indication that a product and/or product characteristic is complete is received 142). The generated 144 report provides an indication to supervising attorneys and others of the status of the accused infringing products.

With continuing reference now to FIG. 1, method 100 may include performing a case analysis, block 146. The case analysis 146 may include receiving a case input, block 148. The received 148 case input may indicate a patent infringement litigation in which a patent is being asserted. A user may input this through a text box, menu, or other input mechanism on an interface displayed on a computing device. Case analysis 146 may include receiving a patent selection or other input, block 150. A user may input this selection through a drop down menu listing previously identified 102 patents, a text box or other input mechanism on an interface displayed on a computing device. Case analysis 146 may include receiving indication of asserted claims, block 152. A user may input this indication by clicking or checking on check boxes, or other input mechanisms, next to a listing of the selected patent's claims on an interface displayed on a computing device. Case analysis 146 may include receiving selection of case defendant, block 154, and accused product(s), block 156. A user may input these selections through a drop down menu listing practicing entities and products, a text box or other input mechanism on an interface displayed on a computing device. Method 100 may display the current initial claim chart for the selected patent, block 158, and display product characteristics for the selected product, block 160, and receive input mapping the product characteristics (and associated evidence) to the claim elements in the initial claim chart, block 162. The user may input this mapping by selecting an element in the displayed chart and selecting a product characteristic in the displayed product characteristic (or in a menu of product characteristics), and repeating until complete. In this manner, the user may indicate which element the user thinks covers which characteristic of the product and method 100 may generate a claim infringement analysis chart (a claim chart with mapping to a product and the product's characteristics, with evidence, showing infringement).

The user may indicate that the mapping of a claim element to a product characteristic, and of the asserted claims to a product, is complete. Consequently, method 100 may receive indication that an element/product characteristic mapping and/or claim/product mapping is complete, block 164. For example, a user may simply click an interface button indicating an element/product characteristic mapping and/or claim/product mapping is complete. Method 100 may generate a report indicating completeness of the mapping block 166. The report may be updated and generated 166 every time there is a change in the completeness of an element/product characteristic mapping and/or claim/product mapping is complete (e.g., an indication that an element/product characteristic mapping and/or claim/product mapping is complete is received 164). The generated 166 report provides an indication to supervising attorneys and others of the status of the accused infringing products. The generated 166 report may include color-coding or other indication of its completeness.

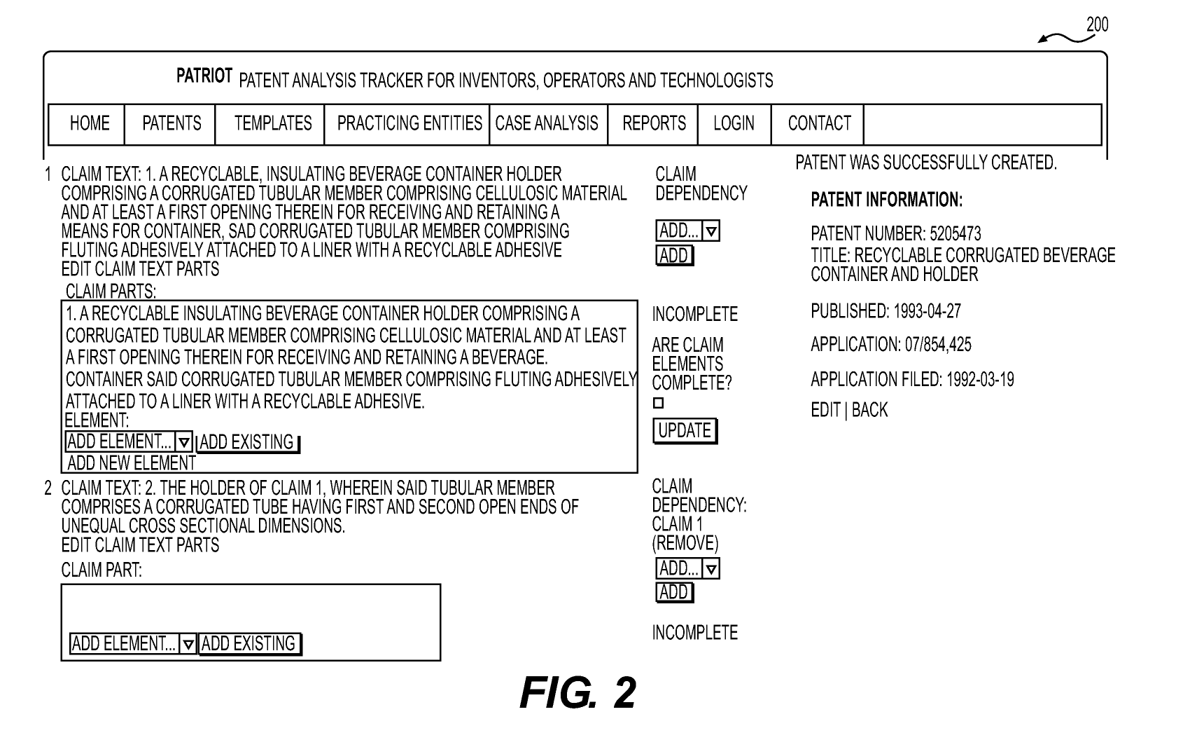

Method 100 may generate a claim infringement analysis chart combining the mapped claim elements and product characteristics, block 168, and ends at block 169. This claim infringement analysis chart is the output that may be submitted to a court to show infringement or used in pre-case analysis to determine whether to proceed with a patent litigation. Steps of method 100 described above may be omitted, skipped or repeated. Likewise, method 100 may include additional steps, such as those apparent from FIGS. 2-10 and the description of FIGS. 2-10 below. The sequence of steps may also be changed; for example, the product templates maybe generated prior to inputting a patent and generating an initial claim chart. Reports illustrating the completeness or lack of completeness of the initial claim chart, products or claim/product mapping may be generated and updated throughout the process, thereby providing an up-to-date illustration of the status of the process.

Embodiments of system and method 100 for automated claim chart generation may be used to generate a claim validity/invalidty analysis chart by replacing the product characteristic template and product creating steps with analogous prior art characteristic/teaching and prior art creating steps. Instead of receiving product characteristics and evidence of same, embodiments of system and method 100 may receive inputs describing characteristics of prior art taught or described by a piece of prior art and evidence from the prior art publication, etc., supporting or showing that teaching or description. The claim validity/invalidity analysis chart may be created by mapping the prior art characteristics and evidence to the claim elements in a similar manner as the product characteristic mapping described above.

Embodiments of system and method 100 for automated claim chart generation may be further enhanced by utilizing a patent and/or prior art database. As described above, claims may be broken down into component parts, and even further into separately tracked claim elements. Therefore, a patent and/or prior art database may be consulted to identify which, if any, documents in the database contain some or all tracked elements of a claim or set of claims. Using the evidence tracking capability described herein, claim elements can be subjected to a variety of search enhancement procedures, such as stemming, frequent/common word elimination, term and/or phrase selection based on parts-of-speech tagging, term expansion to include synonyms and related art terms, projection to lower dimensional and latent spaces, etc. The search enhancement procedures generate a search term, or terms, and methodology to be used based on the claim elements. For example, a set of search terms generated for a particular element may be searched, the results of which can then be organized with reference to the claim element that was the subject of the search. Such searches may be repeated until embodiments have searched for all claim elements. Further, the search may be optionally restricted to provide only statutory bar-type prior art (e.g., patents and printed publications published more than one year before the subject patent was filed), or to provide potential prior art requiring further investigation regarding relative dates of conception, diligence in reduction to practice and the like.

Because embodiments may organize each set of search results with respect to the relevant claim elements, the results can be cross-referenced to determine which of the documents returned by the searches appears most frequently among the sets of results. For example, identifying a document appearing in each set of search results may indicate the existence of an “anticipatory reference” teaching each and every element of at least one claim of the subject patent. More generally, embodiments may separate “stronger” references (i.e., those that teach more of the claim elements identified) from “weaker” references. In addition, identifying “overlapping” references may indicate stronger document combinations when attempting to support an argument that the subject patent should be invalid for obviousness. For example, in a case in which a subject patent claim contains five (5) elements A-E, Document 1 appears in searches for elements A, B and D; Document 2 appears in searches for element A, B, C and E; Document 3 appears in searches for elements C, D and E; and, Document 4 appears in searches for elements A, B and E. In this example, by identifying the overlapping teachings, where multiple elements overlap, focus may be encouraged on a combination of Documents 1 and 2, rather than a combination of Documents 1 and 3.

In addition to overlap, embodiments may user other criteria for evaluating the suitability for various combinations by consulting the patent/prior art database. First, in addition to “overlapping” references, embodiments may compare documents identified in the search process to one another to identify a semantic similarity between the documents. Second, embodiments may use classification data, such as analyzing USPTO main/sub-class, or 1PC classifications to identify similar documents. Third, embodiments may consult assignment and inventorship data to determine whether multiple documents share common ownership or inventorship.

In order to generate a report, embodiments may tag the results of the validity/invalidity analysis, instances of the specific term or terms that resulted in the identification a document in response to a claim element (so-called “hits”), along with the surrounding text, such as the sentence or sentences surrounding the hits, the paragraph containing the hits, or a designated number of words or lines surrounding the hits. Embodiments may use these tagged excerpts as evidence associated with the document characteristics having been previously mapped to the individual claim elements, as described above. Similarly, embodiments may automatically generate a claim chart identifying documents relevant to each of the component parts of the claims, as well as the tagged excerpts providing the reader a narrative to explain the relevance of each identified document, using the document's own text. Separately, or together with the claim chart, embodiments may provide a report identifying, if any, the anticipatory references, the “strongest” references, and the strongest combinations. In addition, because certain individual claims may have anticipatory references associated therewith, while other, narrower claims may not, embodiments may generate a report identifying the claims believed to be anticipated, and claims having relatively stronger, or weaker document combinations associated therewith.

Embodiments of user interfaces may be provided to be displayed on a computing device display and used to receive and process user inputs as described above. The user interfaces may be presented as web pages or other graphical user interfaces (GUIs) that enable a user to enter inputs, including entering text and information, making selections, etc., to interface with embodiments of a system and method for automated claim chart generation, as described above. Such user interfaces enable a user to interact with and provide inputs for a software application that implements embodiments of a system and method for automated claim chart generation. The user interfaces may display the generated claim charts, reports, product templates, etc., described above. The software application may generate the user interfaces, the claim charts, reports, product templates, etc. An initial enter patent interface may be provided by embodiments for entering one or more patents. A user may type in a patent number and click an add patent button. The initial enter patent interface may list previously entered patents. A user may show, edit or delete the listed patents. The initial enter patent interface may be accessed by selecting, i.e., a “Patents” link, on any interface/page displayed by embodiments.

When a patent number is added, e.g., through the initial enter patent interface, embodiments of system and method upload patent information from one or more various sources (e.g., online patent databases). An edit patent interface may be provided by embodiments for editing patent information for an entered patent (e.g., accessed by selecting the “Edit” link on the initial enter patent interface). The edit patent interface allows a user to edit the uploaded patent information as shown. The edit patent interface also allows a user to input one or more patent cases in which the patent is asserted.

When a patent number is added, e.g., through the initial enter patent interface, embodiments of system and method upload the claims of the indicated patent and generates an initial claim chart interface with the uploaded claims.

FIG. 2 illustrates an exemplary initial claim chart 200 generated with claims downloaded from an added patent. The initial claim chart may be accessed, e.g., through selecting the “Show” link on the initial enter patent interface. As described above, embodiments split out claim parts or components in the initial claim chart 200. In embodiments, colons and semi-colons may separate the claim components. If the user thinks that the initial claim chart 200 does not adequately separate the claim components, the user may add new components (e.g., claim elements) by selecting, e.g., “Add New Element.” A type new component interface may be provided by embodiments with text boxes for typing in the new component. After the new component is entered (e.g., typed in), embodiments may make the new component available for adding to other claims in which it appears. If the new component is a repetition of a claim component existing in another claim and previously added, the component may be listed in the pull-down menu shown (“Add Element”). Such a claim component may be selected from the pull-down menu and added by selecting, e.g., “Add Existing.” A user may also edit, delete and add to claim text by selecting, e.g., a “Edit Claim Text Parts” link. An edit claim text parts interface may be provided by embodiments to be displayed when the “Edit Claim Text Parts” link is selected. The edit claim text parts interface allows a user to add additional text, revise text or delete text in the claim. User may also add claim dependencies to claims by selecting a claim from the claim dependency pull down menu

A revised claim chart interface may be generated by embodiments to show a claim chart that has been edited and updated to include additional claim components. Most claims have one or more numbered claim components that appear below the original claim text in the claim parts section. Some claims have components that are repetitive of other claims' components. For example, a dependent claim may repeat a component of an independent claim plus some additional features. Many of the claims also have had the original claim parts (from the initial claim chart) separated into multiple claim parts. All of the claims may be marked as “Complete,” indicating that the revised claim chart is complete.

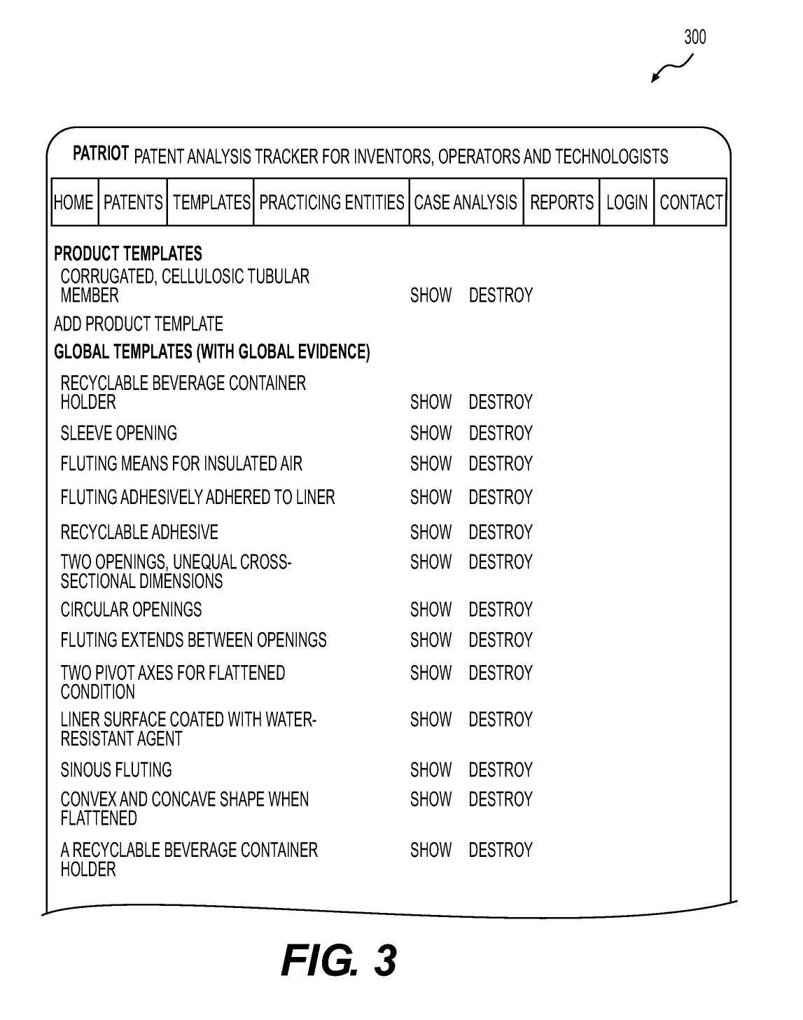

FIG. 3 illustrates an exemplary product templates interface 300. The product templates interface 300 may be accessed by selecting, e.g., a “Templates” link. The product templates interface enables a user to add product templates that are used to input product components, product components' characteristics and evidence showing characteristics of the product components. The product templates may apply to a single product (Product Template) or multiple products (Global Templates). The product templates interface may list previously added product templates to allow a product template to be deleted (e.g., by selecting a “Destroy” link) or shown (e.g., by selecting a “Show” link), or allow a new product template to be added (e.g., by selecting an “Add Product Template” link).

A product template details interface may be provided by embodiments and may be accessed by selecting, e.g., the “Show” link on the product templates, interface 300. The product template details interface may show details of a product template, include a product template name, description, ID, characteristic and evidence showing the product template characteristic. Evidence may be added by selecting, e.g., a “Add New Evidence” link or by selecting previously added evidence from a pull-down menu and selecting, e.g., a “Add Existing Evidence” link. Existing evidence may be added by selecting evidence from the pull-down menu and selecting, e.g., the “Add Existing Evidence” link. An add product characteristic interface may be provided by embodiments and may be accessed by selecting, e.g., an “Add New Characteristic” link on the product template details interface. A user may type in a description of the new characteristic on the add product characteristic interface. An added product characteristic may be, e.g., that the product component comprises an additional feature, such as the color brown.

An add product template interface may be provided by embodiments and may be accessed by selecting, e.g., the “Add Product Template” link. The add product template interface may enable a user to add a product component name and description of the product component. A product template details interface may be provided by embodiments for a newly added product component. The product template details interface may be shown as not including any product characteristics if none have been added.

A practicing entities interface may be provided by embodiments and may be accessed by selecting, e.g., a “Practicing Entities” link. The practicing entities interface may list previously added practicing entities, enable details of each entity to be shown (e.g., by selecting a “Show” link), edited (e.g., by selecting an “Edit” link) or deleted (e.g., by selecting a “Destroy” link). Likewise, new practicing entities may be added by selecting, e.g., an “Add New Practicing Entity” link. A product entity details interface may be provided by embodiments and may be accessed by selecting, e.g., the “Show” link. The product entity details interface may list accused products of a practicing entity, as well as the manufacturer of the accused products and product model numbers. The accused products may be edited or deleted. Likewise, the characteristics of the accused product may be viewed (an edited) by selecting, e.g., a “View Characteristics” link. Additional accused products may be added by selecting, e.g., an “Add New Product” link.

A product details/chart interface may be provided by embodiments and may be accessed by selecting, e.g., a “View Characteristics” link. The product details/chart interface lists various characteristics of the accused product. The product details/chart may be built using the product templates generated as above. A listing of product templates may be provided/listed in a menu. Product component(s) may be selected and added by selecting one or more of product templates from the menu and selecting, e.g., an “Add from Template” link. Making such selections will populate the product details/chart interface with the product components and corresponding evidence previously added. Alternatively or additionally, a user may add additional new characteristics or evidence by selecting, e.g., “Add New Characteristic” or “Add New Evidence” links, respectively, an adding as described above. Evidence and/or characteristics may also be removed by selecting, e.g., “Remove” links. A new product details/chart interface may be provided by embodiments that shows no product components, characteristics or evidence added. Instead, existing product templates may be listed for selection.

An editing product interface may be provided by embodiments and may be accessed by selecting, e.g., the “Edit” link on the product entity details interface. A user may edit/input the product name, manufacturer, model number, case defendant number or additional information relevant to the accused product. An add new product interface may be provided by embodiments and may be accessed by selecting, e.g., the “Add New Product” link.

A case interface may be provided by embodiments and may be accessed by selecting, e.g., a “Case Analysis” link. The case interface lists existing case analysis interfaces that have been created. In embodiments, case analysis interfaces may exist and be listed before filing a patent litigation (pre-filing) or during a patent litigation (post-filing). Alternatively, case interface may make no distinction between such case analysis interfaces. Case analysis interfaces may be shown (e.g., by selecting a “Show” link), edited (e.g., by selecting an “Edit” link) or deleted (e.g., by selecting “Destroy” link). Additional case analysis interfaces may be generated by selecting, e.g., a “New Case” link. A new case page may be accessed by selecting, e.g., the “New Case” link.

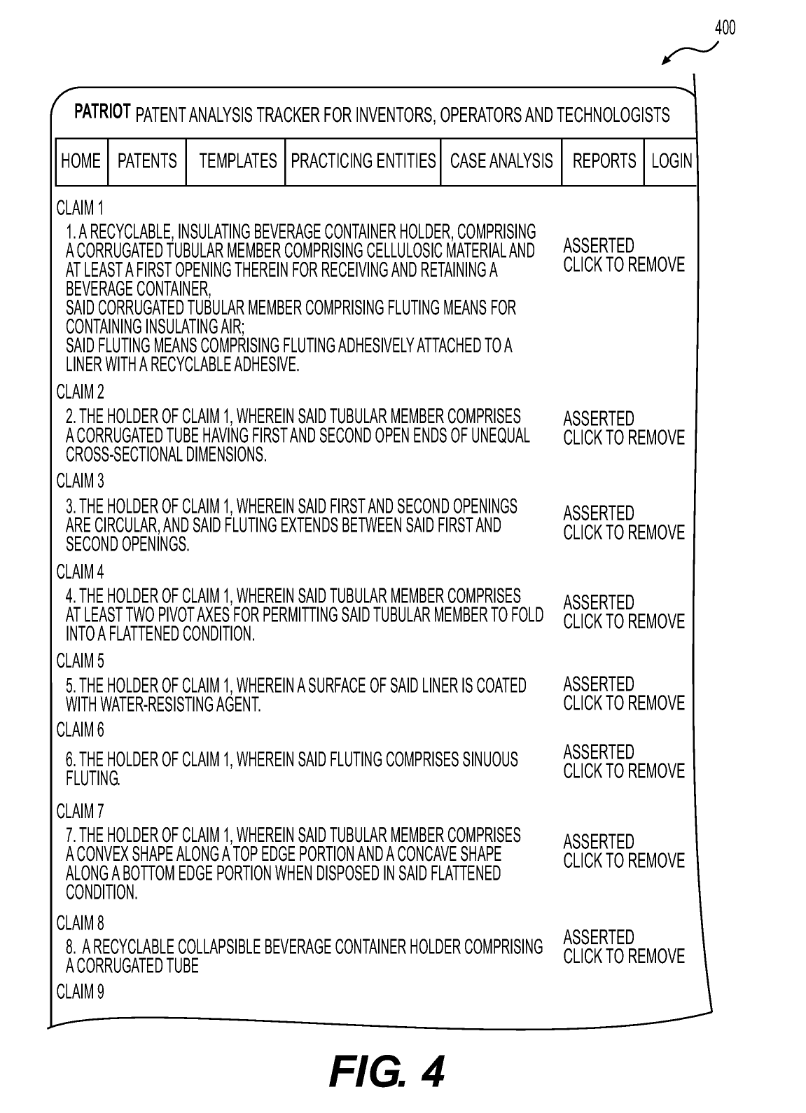

A case analysis interface may be provided by embodiments and may be accessed by selecting, e.g., the “Show” link. Case analysis interface lists patents and defendants in a case, as well as other case information. Additional patents may be added by selecting patents from a patent menu and selecting, e.g., “Add.” For example, the initial enter patent interface may be accessed through a “Manage Patents” link. Additional defendants may be added by selecting a practicing entity from a defendant menu and selecting, e.g., “Add.” Adding a patent adds the claim charts corresponding to the patent. Adding a practicing entity adds the product chart corresponding to the practicing entity. FIG. 4 illustrates an exemplary claim assertion interface 400 that may be accessed by selecting a “Manage Claim Assertions” link. The claim assertion interface indicates which claims are asserted and which are not. A user may select, e.g., a “click to assert” link to indicate a claim is asserted and a “click to remove” link to indicate a claim is not asserted. An accused products interface may be provided by embodiments and may be accessed by selecting, e.g., a “Products Infringements” link on the case analysis interface. Selecting, e.g., a “Map Patent Elements” link may access a map patent elements interface on which a patent may be selected (i.e., one of the patents listed on the case analysis interface) to access a claim-to-product mapping claim chart that illustrates a mapping of claim components to product components used to present an infringement case.

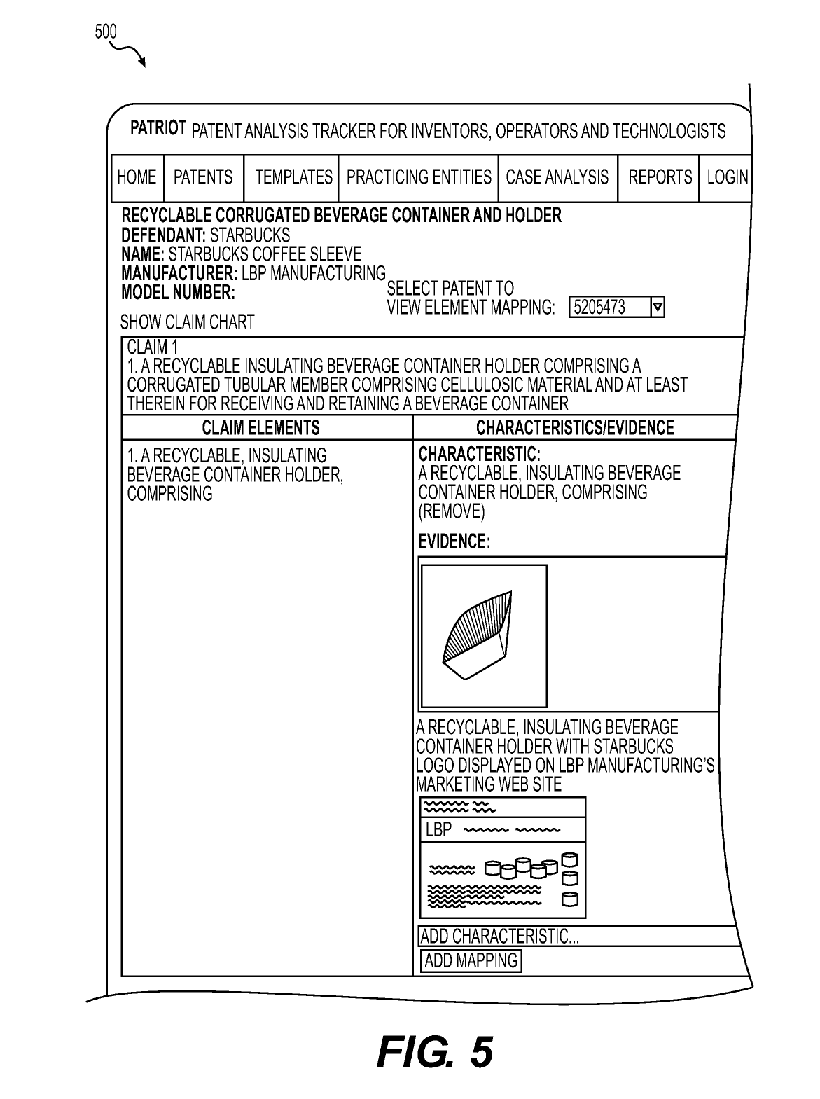

FIG. 5 illustrates portions of an exemplary claim-to-product mapping claim chart 500. The claim chart 500 may show each asserted claim component (e.g., as determined by claims asserted on the claim assertion interface and defined above using, e.g., the edit patent interface, the initial claim chart interface, the type new component interface, the edit claim text parts interface, and the revised claim chart interface) is listed (e.g., under “claim elements”). The claim chart 500 may show the selected product components, including characteristics and supporting evidence, that map to each claim component. The claim chart 500 may also show an indication that a given claim component's evidence mapping is complete or incomplete. Additional product characteristics and evidence may be added by selecting a product characteristic from a menu and selecting, e.g., “Add Mapping.” In embodiments, when a product characteristic is added, the claim component mapping status is automatically changed to incomplete.

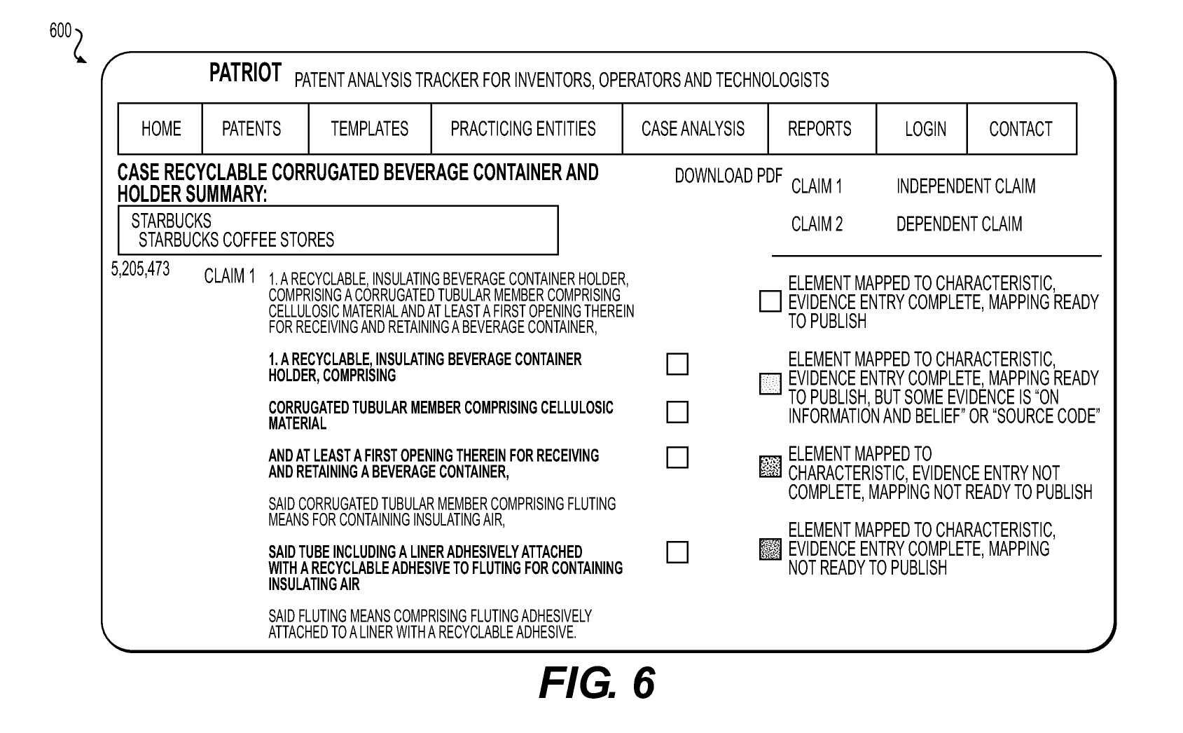

On the case analysis interface, a “View Evidence Status by Product” link may be provided by embodiments to access an evidence status report. FIG. 6 illustrates portions of an exemplary evidence status report 600. Such evidence status may be shown by color-coding, shading or other keys. A “View Claim Chart” link may be selected to access a “production-version” final claim chart corresponding to the claim chart 500 shown in FIG. 5.

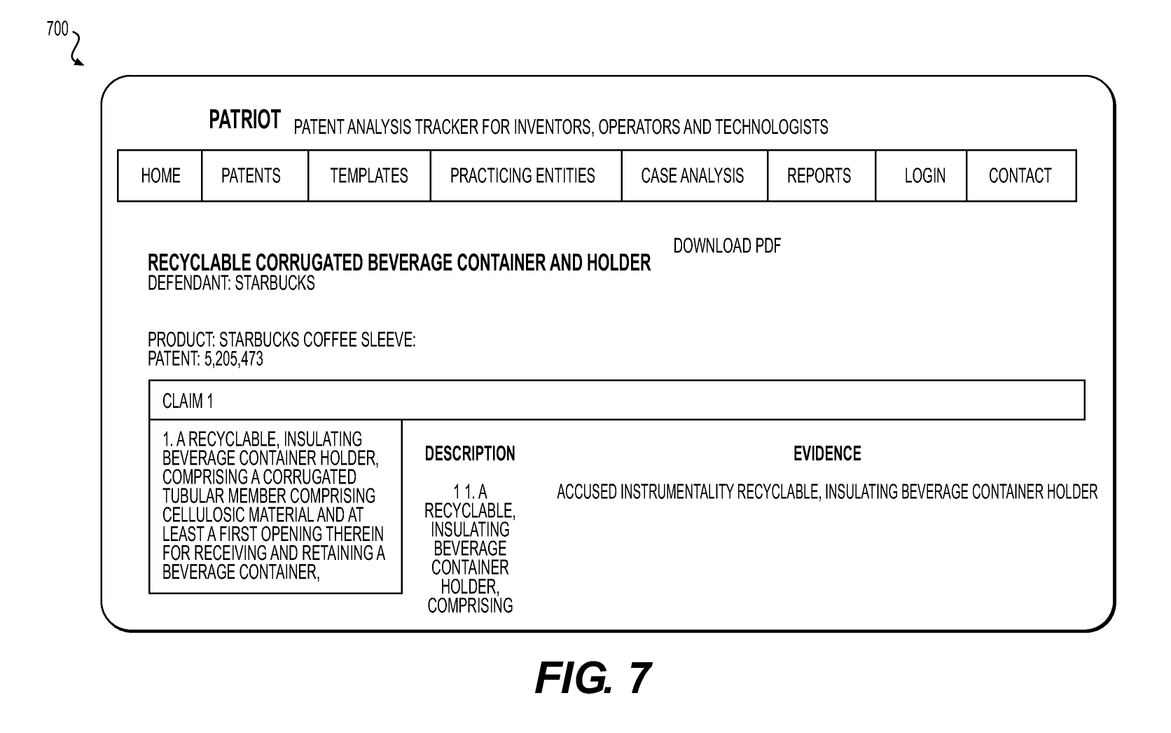

FIG. 7 illustrates portions of an exemplary final claim chart 700. A downloaded portable document format (PDF) interface may be may be provided by embodiments and may include a “Download PDF” link that enables the final claim chart to be downloaded as a PDF file. The final production version of the claim chart may include larger photographs or graphic evidence to be easier to view.

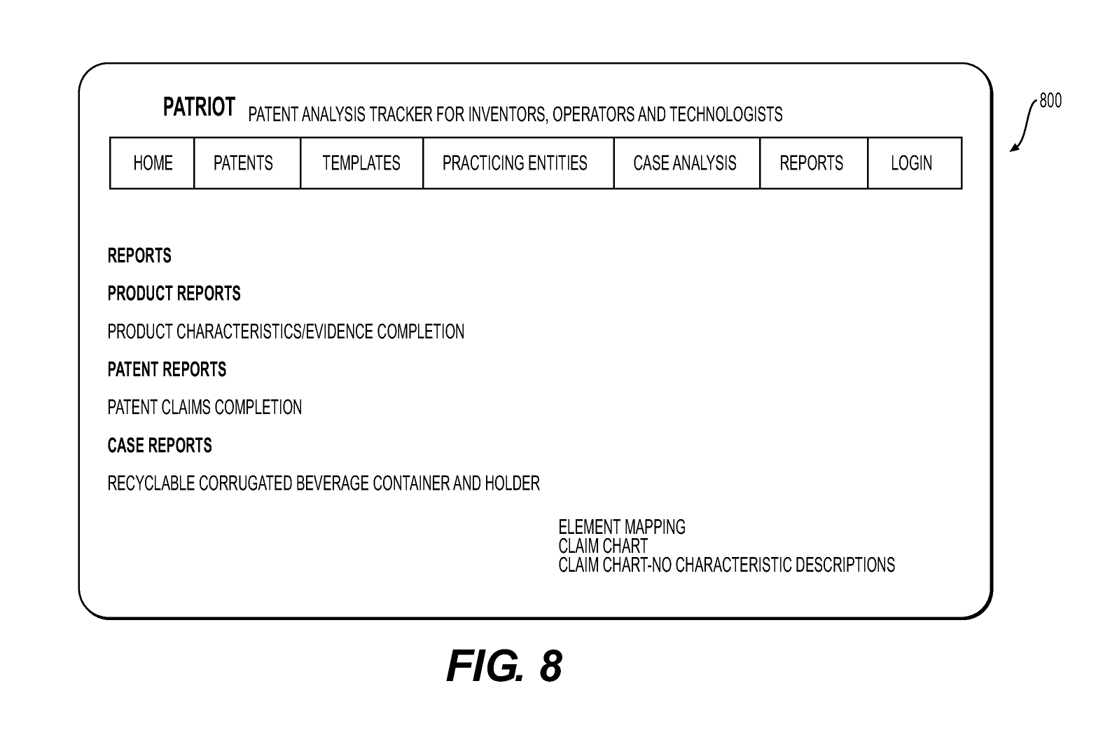

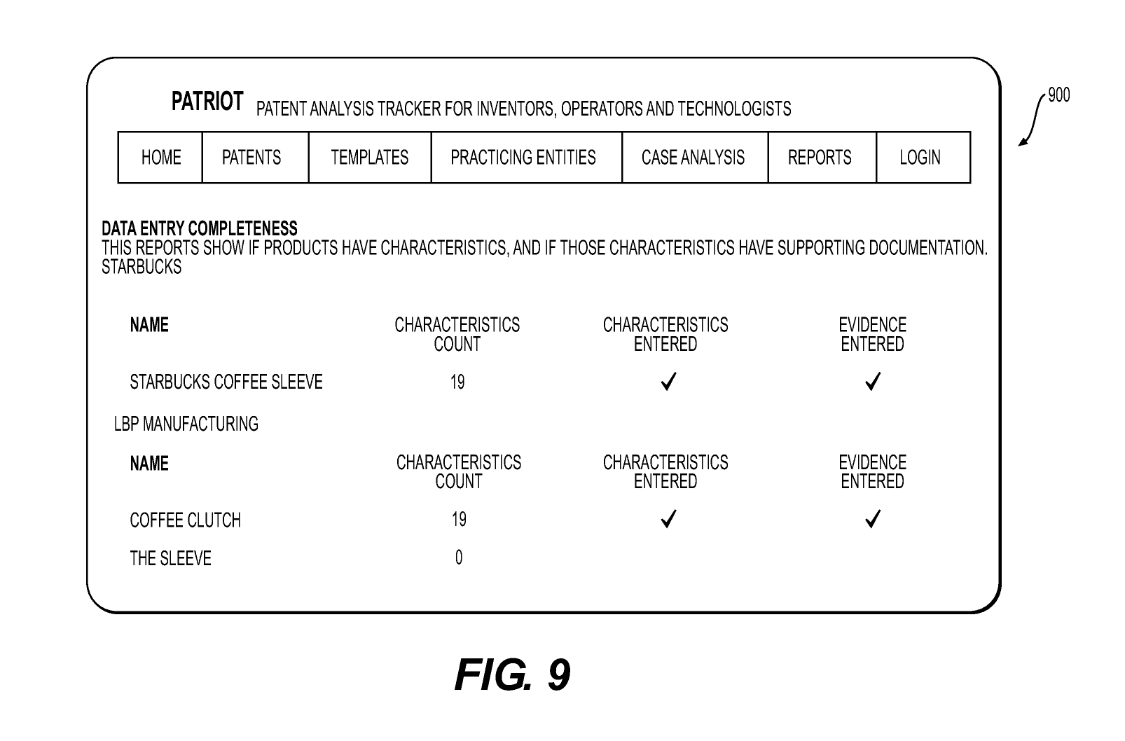

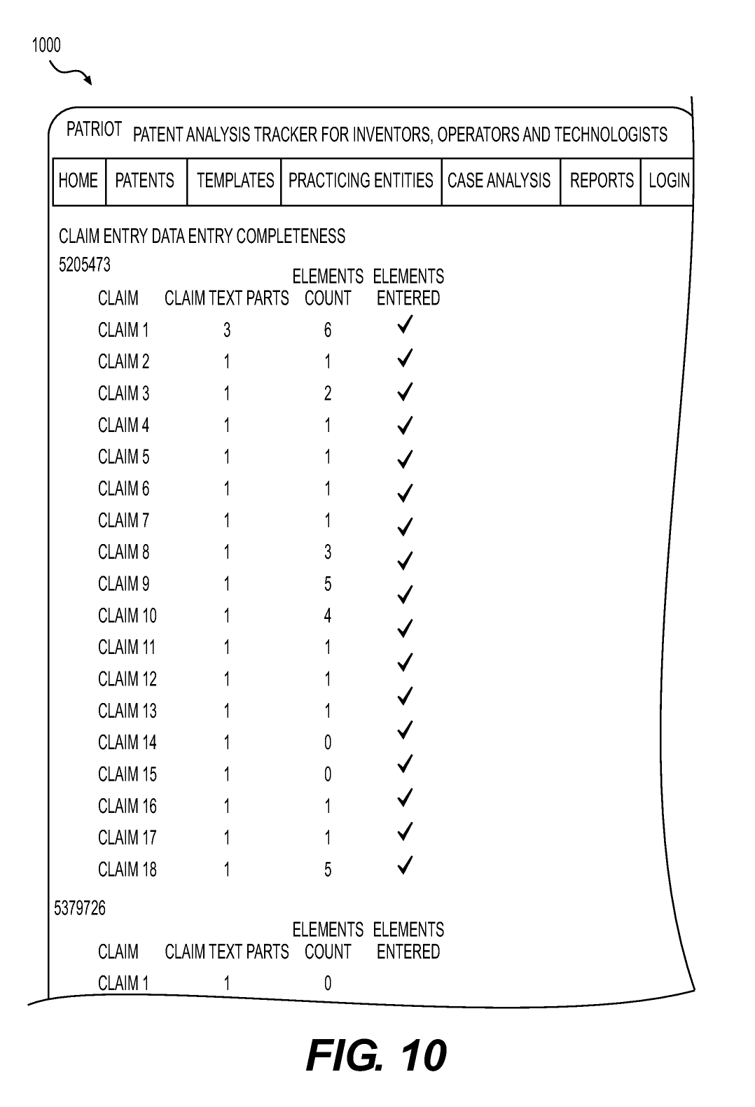

FIG. 8 shows an exemplary reports interface 800 that includes a “Product Characteristics/Evidence Completion” icon that may access a product characteristics/evidence completion report 900, such as shown in FIG. 9. A “Patent Claims Completion” link may access a claim data entry completeness report 1000, such as shown in FIG. 10. An “Element Mapping” link may access the evidence status report. A “Claim Chart” link may access the production version final claim chart 700 shown in FIG. 7. A “Claim Chart—No Characteristic Description” link may access a production version final claim chart without characteristic description (i.e., with only evidence). Note that all claims, evidence, products, entities, etc., are used purely as illustrative examples.

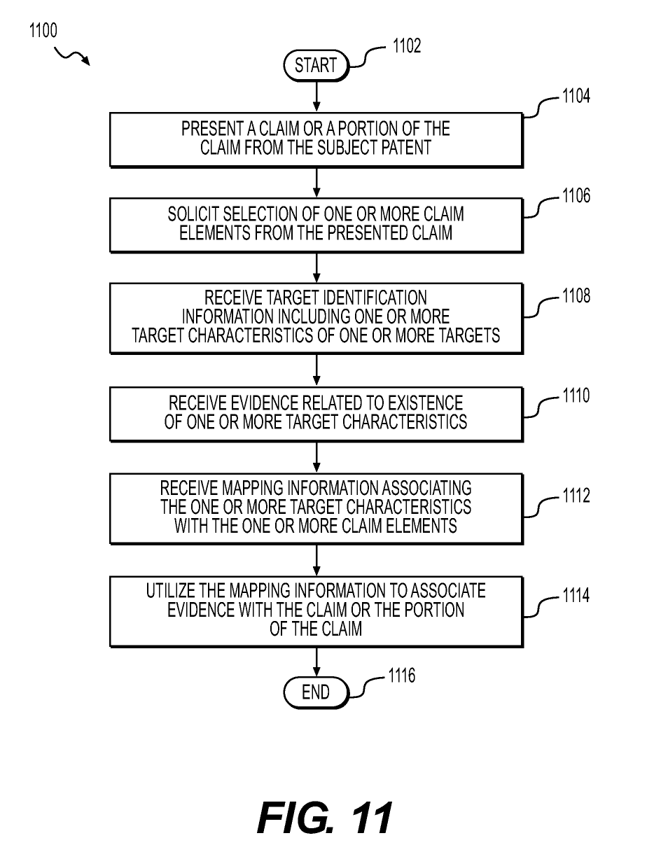

FIG. 11 is a flow chart illustrating another embodiment of a method 1100 for automated claim chart generation. Method starts 1102 by presenting a claim or a portion of the claim from the subject patent (block 1104). The method 1100 solicits selection of one or more claim elements from the presented claim (block 1106), receives target identification information including one or more target characteristics of one or more targets (block 1108), receives evidence related to existence of one or more target characteristics (block 1110), receives mapping information associating the one or more target characteristics with the one or more claim elements (block 1112), and utilizes the mapping information to associate evidence with the claim or the portion of the claim (block 1114). As a result, when evidence associated with a claim element found in multiple claims is changed, the association of the mapping information provides like changes to other instances of the same claim element. The method may end at block 1116).

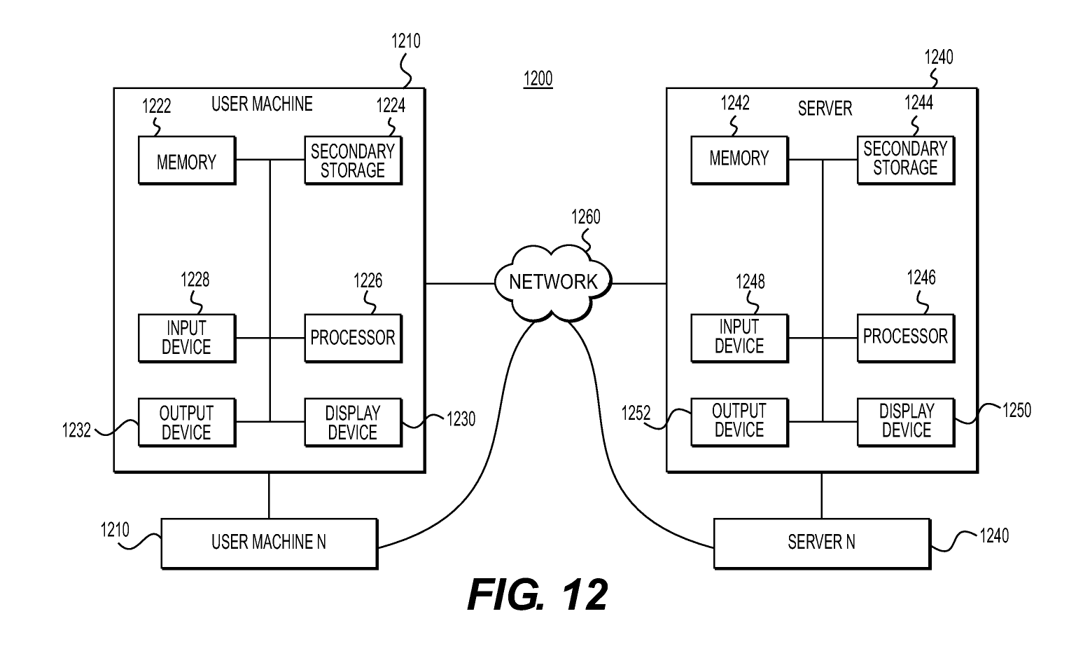

With reference now to FIG. 12, shown is a block diagram illustrating exemplary hardware components for implementing an embodiment of system 1200 for automated claim chart generation. System 1200 includes a user machine 1210 connected with a network 1260 such as the Internet, providing a network connection to server 1240. Other user machines, may also be connected with network 1260 for other users.

User at user machine 1210 interact with server 1240 to enter inputs and make selections as described above with reference to FIGS. 1-10. Server 1240 executes application(s) for performing embodiments of method (e.g., as illustrated in FIG. 1) for automated claim chart generation and stores the input, generated claim charts, product templates, reports, etc. Alternatively, applications may be executed on user machine 1210, which may also store the input, generated claim charts, product templates, reports, etc. System 1200 may also include the ability to access one or more web site servers in order to obtain content from the World Wide Web, if desired.

User machine 1210 typically includes a memory 1222, a secondary storage device 1224, a processor 1226, an input device 1228, a display device 1230, and an output device 1232. Memory 1222 may include random access memory (RAM) or similar types of memory, and it may store one or more applications, and a web browser, for execution by processor 1226. Secondary storage device 1224 may include a hard disk drive, floppy disk drive, CD-ROM drive, or other types of non-volatile data storage. Processor 1226 may execute applications or programs stored in memory 1222 or secondary storage 1224, or received from the Internet or other network, and the processing may be implemented in software, such as software modules, for execution by computers or other machines. These applications preferably include instructions executable to perform the methods described above, with reference to FIG. 1. The applications preferably provide graphical user interfaces (GUIs) through which user may enter inputs, etc., such as interfaces shown in FIGS. 2-10. Input device 1228 may include any device for entering information into machine 1210, such as a keyboard, mouse, cursor-control device, touch-screen, microphone, digital camera, video recorder or camcorder. The input device 1228 may be used to enter information into GUIs during performance of the method 100 or 1100 described above. Display device 1230 may include any type of device for presenting visual information such as, for example, a computer monitor or flat-screen display. The display device 58 may display the GUIs described above. Output device 1232 may include any type of device for presenting a hard copy of information, such as a printer, and other types of output devices include speakers or any device for providing information in audio form.

Examples of user machines 1210 include personal computers, laptop computers, notebook computers, palm top computers, network computers, or any processor-controlled device capable of executing a web browser or other type of application for interacting with the system.

Server 1240 typically includes a memory 1242, a secondary storage device 1244, a processor 1246, an input device 1248, a display device 1250, and an output device 1252. Memory 1242 may include RAM or similar types of memory, and it may store one or more applications for execution by processor 1246. Secondary storage device 1244 may include a hard disk drive, floppy disk drive, CD-ROM drive, or other types of non-volatile data storage. Processor 1246 executes the application(s), which is stored in memory 1222 or secondary storage 1244, or received from the Internet or other network 1260. Input device 1248 may include any device for entering information into server 1240, such as a keyboard, mouse, cursor-control device, touch-screen, microphone, digital camera, video recorder or camcorder. Display device 1250 may include any type of device for presenting visual information such as, for example, a computer monitor or flat-screen display. Output device 1252 may include any type of device for presenting a hard copy of information, such as a printer, and other types of output devices include speakers or any device for providing information in audio form.

Server 1240 may store a database structure in secondary storage 1244, for example, for storing and maintaining information related to the generation of claim charts as described herein.

Also, processor 1246 may execute one or more applications in order to provide the functions described in this specification, specifically in method 100 or 1100 described above, and the processing may be implemented in software, such as software modules, for execution by computers or other machines. The processing may provide and support web pages and other GUIs described in this specification and otherwise for display on display devices associated with the user machines 1210. The GUIs may be formatted, for example, as web pages in HyperText Markup Language (HTML), Extensible Markup Language (XML) or in any other suitable form for presentation on a display device depending upon applications used by users to interact with the system 1200.

Although only one server 1240 is shown, system 1200 may use multiple servers as necessary or desired to support the users and may also use back-up or redundant servers to prevent network downtime in the event of a failure of a particular server. In addition, although machine 1210 and server 1240 are depicted with various components, one skilled in the art will appreciate, that these machines and the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as machine 1210 and server 1240, to perform a particular method, such as method 100.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for generating a claim chart for comparing a subject patent to a target, the method being implemented by one or more computers each including at least one processor, the method comprising:
presenting a claim or a portion of the claim from the subject patent;
soliciting selection of one or more claim elements from the presented claim;
receiving target identification information including one or more target characteristics of one or more targets,
receiving evidence related to existence of one or more target characteristics;
receiving mapping information associating the one or more target characteristics with the one or more claim elements; and
utilizing the mapping information to associate evidence with the claim or the portion of the claim, using the at least one processor.

2. The method of claim 1, whereby when evidence associated with a claim element found in multiple claims is changed, the association of the mapping information provides like changes to other instances of the same claim element

3. The method of claim 1, wherein the target is a product.

4. The method of claim 3, wherein the receiving target identification information step comprises assigning a unique identifier to each of the one or more target characteristics.

5. The method of claim 4, wherein the receiving evidence step comprises saving the unique identifier, the one or more target characteristics, the evidence showing that the product has the one or more target characteristics in a product template, wherein when two or more products share a same characteristic, a user can select a product template for the same characteristic to avoid recreating the same characteristic for another product.

6. The method of claim 3, further comprising creating practicing entities and products information by receiving information describing one or more practicing entities that provide the product and receiving information describing the product.

7. The method of claim 6, wherein the practicing entities information includes one or more of a name and address, and wherein the product information includes one or more of a name, model number and manufacturer.

8. The method of claim 6, wherein the creating the practicing entities and products information step includes adding product characteristics to the product.

9. The method of claim 1, further comprising receiving a case input indicating a patent infringement litigation in which a patent is being asserted.

10. The method of claim 11, wherein the receiving the case input step includes receiving user input using a text box or a menu on a user interface.

11. The method of claim 1, further comprising receiving a selection of case defendants and accused products by receiving user input using a text box or a drop down menu listing the practicing entities and products.

12. The method of claim 1, wherein the target is prior art.

13. The method of claim 1, further comprising creating one or more claim element templates for the one or more claim elements, wherein a user can select a claim element template for a same element to avoid editing the same element in another claim.

14. A method for generating a claim chart for comparing a subject patent to a target, the method being implemented by one or more computers each including at least one processor, the method comprising:
presenting, on a display of a user computer, a claim or a portion of the claim from the subject patent;
soliciting selection from a user of one or more claim elements from the presented claim;
receiving target identification information including target characteristics of one or more targets,
receiving evidence related to existence of one or more target characteristics;
receiving mapping information associating the one or more target characteristics with the one or more claim elements; and
utilizing the mapping information to associate evidence with the claim or the portion of the claim, using the at least one processor,
whereby when evidence associated with a claim element found in multiple claims is changed, the association of the mapping information provides similar changes to other instances of the same claim element.

15. The method of claim 14, wherein the target is a product.

16. The method of claim 15, wherein the receiving evidence step comprises saving the unique identifier, the one or more target characteristics, the evidence showing that the product has the one or more target characteristics in a product template, wherein when two or more products share a same characteristic, a user can select a product template for the same characteristic to avoid recreating the same characteristic for another product.

17. The method of claim 14, wherein the target is prior art.

18. The method of claim 13, further comprising creating one or more claim element templates for the one or more claim elements, wherein a user can select a claim element template for a same element to avoid editing the same element in another claim.

19. The method of claim 13, further comprising receiving a case input indicating a patent infringement litigation in which a patent is being asserted.

20. The method of claim 18, wherein the receiving the case input step includes receiving user input using a text box or a menu on a user interface displayed on the display device.
